(19) United States
(12) Patent Application Publication
(10) Pub. No.: US 2006/0256121 A1
(43) Pub. Date: Nov. 16, 2006

(54) Method and apparatus for storing image data

(76) Inventors: Pai-Chu Hsieh, Taipei City (TW); Tzu-Hsin Wang, Hsinchu City (TW); Chien-Yu Lin, Sanchong City (TW)

Correspondence Address: J C PATENTS, INC., 4 VENTURE, SUITE 250, IRVINE, CA, 92618, US

(21) Appl. No.: 11/197,819

(22) Filed: Aug. 5, 2005

(30) Foreign Application Priority Data
May 11, 2005 (TW) 94115165

(51) Int. Cl. G06F 12/02

(52) U.S. Cl. 345/544

(57) ABSTRACT

A method and an apparatus for saving image data are disclosed. This method adopts a pixel processor to separate the pixel values of an image data into a plurality of pixel groups according to the highest sub-sample rate and the data width of the memory. Then, those pixel groups are stored in different memory blocks of the memory after being recombined such that sub-sample images can be efficiently obtained under a condition that only full-resolution image is stored, thus improving disadvantage of storing low-resolution image separately in prior art. Besides, the data of those pixel groups are arranged alternately such that every memory block can be opened evenly and alternately when storing/reading sub-sample and original image, thus enhancing the efficiency of memory use.

### CROSS-REFERENCE TO RELATED APPLICATION

This application claims the priority benefit of Taiwan application serial no. 94115165, filed on May 11, 2005. All disclosure of the Taiwan application is incorporated herein by reference.

### BACKGROUND OF THE INVENTION

1. Field of Invention

The present invention relates to a method for saving image data. More particularly, the present invention relates to a method for storing image data to obtain images of full, 2, 4 . . . , and 2ⁿ times' sub-sample rates.

2. Description of Related Art

FIG. 1 is a block diagram of an image coder using hierarchical motion estimation method. When coding image data, one to multiple low-resolution, reduced images are also needed in addition to an original full-resolution image for the coarse motion estimation 120, and the method for generating reduced images includes filtering pixels of the original image using an image filter 110, and then reducing the resolution, or reducing the sub-sample of the pixels in the original image directly. However, in conventional methods, low-resolution image data are always generated and stored in an additional memory when it's implemented by hardware, and that takes up the memory space.

In addition, in the method of reducing the sub-sample of pixels, the values of low-resolution pixels and the values of full-resolution pixels are the same. In theory, the sub-sample images need not be stored; instead the sub-sample image data can be obtained by hop-reading from the full-resolution image data, as the data structure of hop-reading parity pixels shown in FIG. 2. But the operation is restricted in practice. When the memory takes characters as the storage unit, it is impossible to hop-read pixel data in bit units efficiently, thus low-resolution images have to be stored separately for reading convenience when it's implemented in the hardware.

### SUMMARY OF THE INVENTION

The present invention is directed to a method for saving image data, by which pixels of an original image data are separated according to the highest sub-sample rate and are stored into the memory after being re-arranged, so that sub-sample images need not stored separately when only full-resolution image data are stored, thus reducing the required memory space and bandwidth.

The present invention is also directed to an apparatus for saving image data, which adopts a pixel processor to separate the pixels of a received image according to the highest sub-sample rate, and stores them into different memory blocks of the memory after being re-arranged according to the data width of the memory, thus improving the reading efficiency of the memory.

The present invention provides a method for storing image data, which is used for obtaining images of full, 2, 4 . . . , and 2ⁿ times' sub-sample rates from a stored data, and steps of the method include separating the pixels P_{x,y} of an x^{th} pixel line into 2ⁿ pixel groups, referred to as 1^{st}, 2^{nd} . . . , and n^{th} pixel group respectively. Pixels in the 1^{st} pixel group include P_{x,1}, P_{x, 2}ⁿ₊₁ . . . , and P_{x, k*2}ⁿ₊₁, pixels in the 2^{nd} pixel group include P_{x,2}, P_{x, 2}ⁿ₊₂ . . . , and P_{x, k*2}ⁿ₊₂, and so on. Pixels in the 2ⁿth pixel group include P_{x, 2}ⁿ, P_{x, 2}ⁿ₊₂ⁿ . . . , and P_{x, k*2}ⁿ₊₂ⁿ, wherein k, n, x, y are all integers greater than 0. Then the pixels in the pixel groups are recombined according to the data width of the memory and stored into different 2ⁿ memory blocks of the memory respectively.

According to the embodiments of the present invention, the method for storing image data further includes storing pixel groups of every pixel line into different memory blocks of the memory respectively, so that the pixels of pixel lines in every memory block belong to different pixel groups.

According to the embodiments of the present invention, the method for saving image data further includes repeating the step of separating pixels of pixel lines until every pixel line of the image data is separated into 2ⁿ pixel groups.

According to the method for image data storage described in the embodiments of the present invention, when the data stored in the pixel groups reach a certain quantity, the pixel groups are stored respectively into the memory blocks of the memory after being recombined according to the data width of the memory.

According to the embodiments of the present invention, the method for saving image data further includes arranging/storing odd number and even number of pixel groups alternately in the memory blocks of the memory with a plurality of pixel lines as a unit, so that the memory blocks will be opened alternately when they are accessed.

According to the embodiments of the present invention, if the method for saving image data uses frame-based sub-sample images, odd number and even number of pixel groups are arranged alternately in the memory blocks of the memory with a plurality of frame pixel lines as a unit.

According to the embodiments of the present invention, if the method for saving image data uses field-based sub-sample images, then odd number and even number of pixel groups are arranged alternately in the memory blocks of the memory with a plurality of field pixel lines as a unit, including arranging the pixel groups of the top field pixel line and the bottom field pixel line alternately in the memory blocks of the memory.

The present invention provides an apparatus for saving image data, which includes a pixel processor used for separating pixels of every pixel line of the image data into 2ⁿ pixel groups; a memory controller, coupled to the pixel processor, used for recombining pixels of the pixel groups according to the data width of the memory; and 2ⁿ memory blocks coupled to the memory controller, used for storing the recombined pixel groups, so that pixels of pixel lines belong to different pixel groups in every memory block.

According to the apparatus for saving image data described in the embodiments of the present invention, the pixel processor further includes a plurality of data buffers used for storing a plurality of pixel values of the image data; a data buffer controller coupled to the data buffers, for separating the pixel values stored in the data buffers into pixel groups according to the positions of the pixels in the image data, and storing them back into the data buffers according to the data width.

According to the apparatus for saving image data in the embodiments of the present invention, when the data buffers are fully stored with pixel values, the pixel groups are stored into the memory blocks respectively after they are recombined by the memory controller.

Since the present invention adopts a pixel processor to separate and recombine the pixel values of an image data into a plurality of pixel groups according to the highest sub-sample rate and the data width of the memory, and to store them separately after arranging them alternately, the required memory space and bandwidth can be reduced, and the access efficiency of the memory can be enhanced.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an image coder using hierarchical motion estimation method.

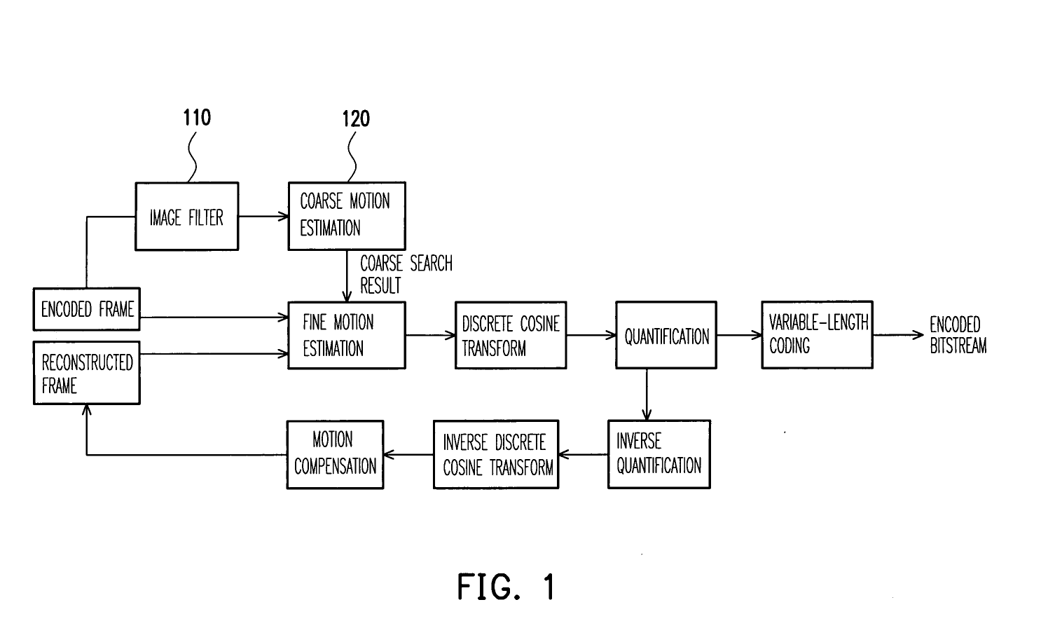

FIG. 2 illustrates the data structure of hop-reading parity pixel.

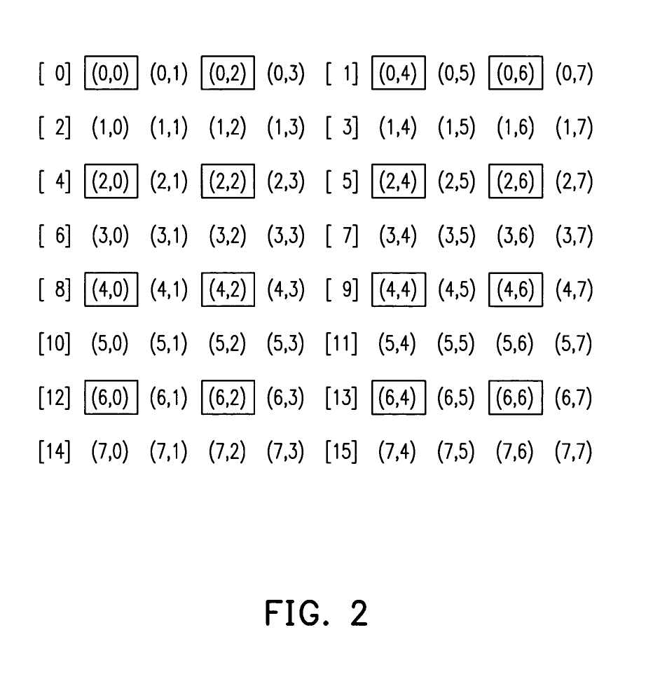

FIG. 3 is a block diagram of an apparatus for saving image data according to an embodiment of the present invention.

FIG. 4 is a flowchart illustrating the method for saving image data according to an embodiment of the present invention.

FIG. 5 is a block diagram of an apparatus for storing image data of 2 times' highest sub-sample rate according to another embodiment of the present invention.

FIG. 6 illustrates the data structure for storing image data of 2 time's highest sub-sample rate according to another embodiment of the present invention.

FIG. 7 illustrates the data structure of 2 time's highest sub-sample rate which reads 2 times' sub-sample rate data from the memory according to another exemplary of the present invention.

FIG. 8 illustrates the data structure of 2 times' highest sub-sample rate which reads original resolution image data from the memory according to another embodiment of the present invention.

FIG. 9 illustrates the data structure for storing image data of 4 times' highest sub-sample rate according to yet another embodiment of the present invention.

### DESCRIPTION OF EMBODIMENTS

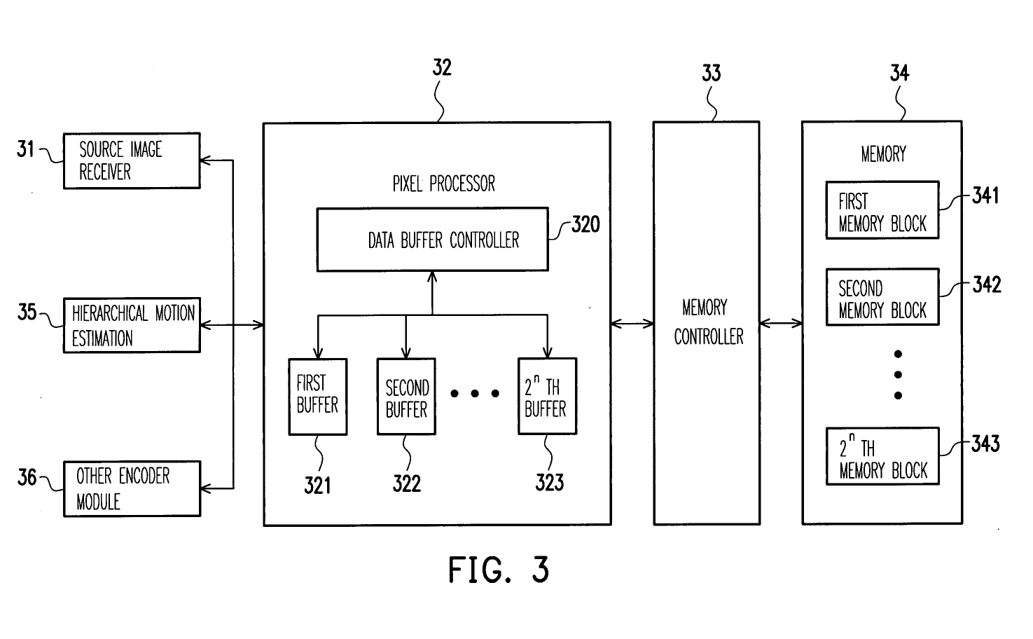

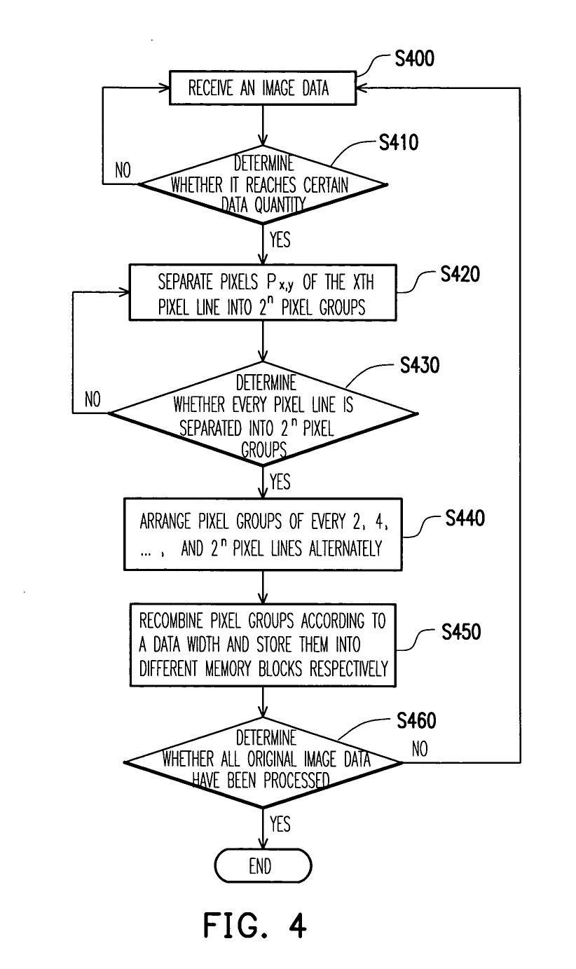

FIG. 3 is a block diagram of an apparatus for storing image data and FIG. 4 is a flowchart illustrating the method for storing image data according to an embodiment of the present invention. Referring to both FIGS. 3 and 4, firstly, an original image data is received by source image receiver 31, and the pixel values of the original image are stored by a plurality of buffers including 1^{st} buffer 321, 2^{nd} buffer 322 . . . , and 2ⁿth buffer 323 in the pixel processor 32 (step S400).

Thereafter, it's determined whether the pixel values stored in the buffers have reached certain data quantity (step S410); if not, continue receiving and storing original image data (step S400); if yes, pixel processor 32 reads the x^{th} pixel line of the stored original image data according to the highest sub-sample rate, and separates them into 2ⁿ pixel groups (step S420), by using its data buffer controller 320. Then the above operations are repeated, and it's determined whether every pixel line of the stored original image data is separated into 2ⁿ pixel groups (step S430); if not, continue the separation in step S420; if yes, then store the pixels back into the buffers according to the data width of the memory after they are recombined.

Thereafter, the data structures stored alternately according to parity pixels are arranged alternately (step S440) through memory controller 33, and are written respectively into memory blocks of memory 34 including 1^{st} memory block 341, 2^{nd} memory block 342 . . . , and 2ⁿth memory block 343 (step S450). Finally it's determined whether all original image data have been processed (step S460); if not, then the aforementioned receiving, processing, and storing operations are repeated; if yes, then the data storage operation is finished.

In addition, when hierarchical motion estimation 35 needs to sub-sample image data, the sub-sample image data stored using the data structure is read, and sent to hierarchical motion estimation 35 for subsequent processing; when the modules in the coder need full-resolution image data, the full-resolution image data stored using the data structure is read, and the separated parity pixels are recombined and sent to the modules which need the data for subsequent processing.

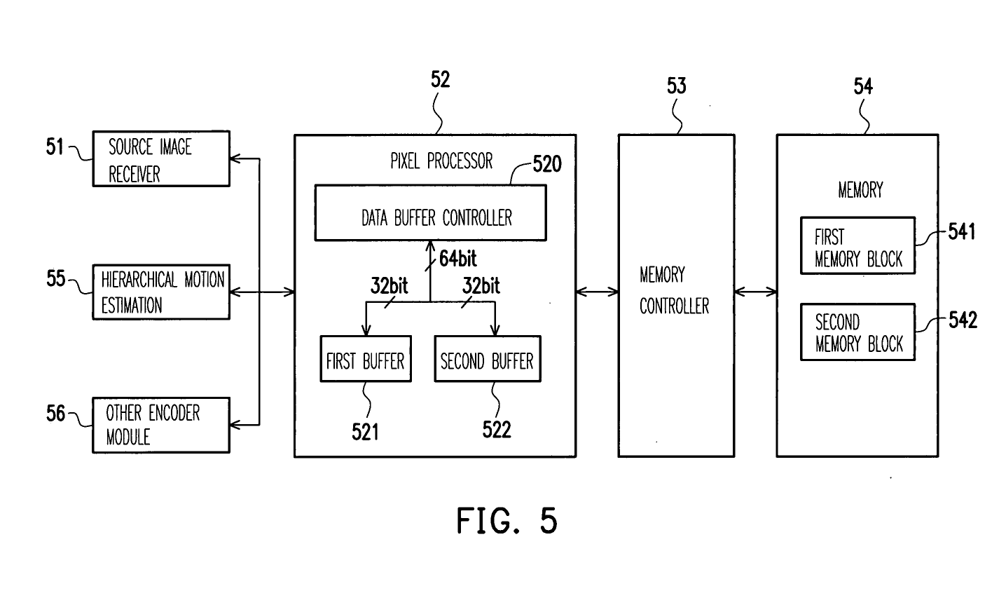

FIG. 5 is a block diagram of an apparatus for storing image data of 2 times' highest sub-sample rate according to another embodiment of the present invention, wherein the functions of source image receiver 51, pixel processor 52, memory controller 53, memory 54, and data buffer 520 are identical to the functions of the source image receiver 31, pixel processor 32, memory controller 33, memory 34, and data buffer 320, therefore the description is not repeated. Since the present embodiment takes 2 times' sub-sample as an example, accordingly, first buffer 521 and second buffer 522 of the buffers in the pixel processor 52 are taken as one group, while first memory block 541 and second memory block 542 of the memory blocks in memory 54 are also taken as one group, and the data width of memory 54 and the bus are both 32 bits (i.e. 4 pixels). To improve the efficiency of memory 54 and the bus, every buffer in pixel processor 52 can store 8 batches of data, therefore memory controller 53 processes the data in the 2^{nd} memory block 542 after it has finished processing the data in the 1^{st} memory block 541. In addition, a hierarchical motion estimation 55 for receiving sub-sample image data and other code module 56 for receiving original resolution image data are also included.

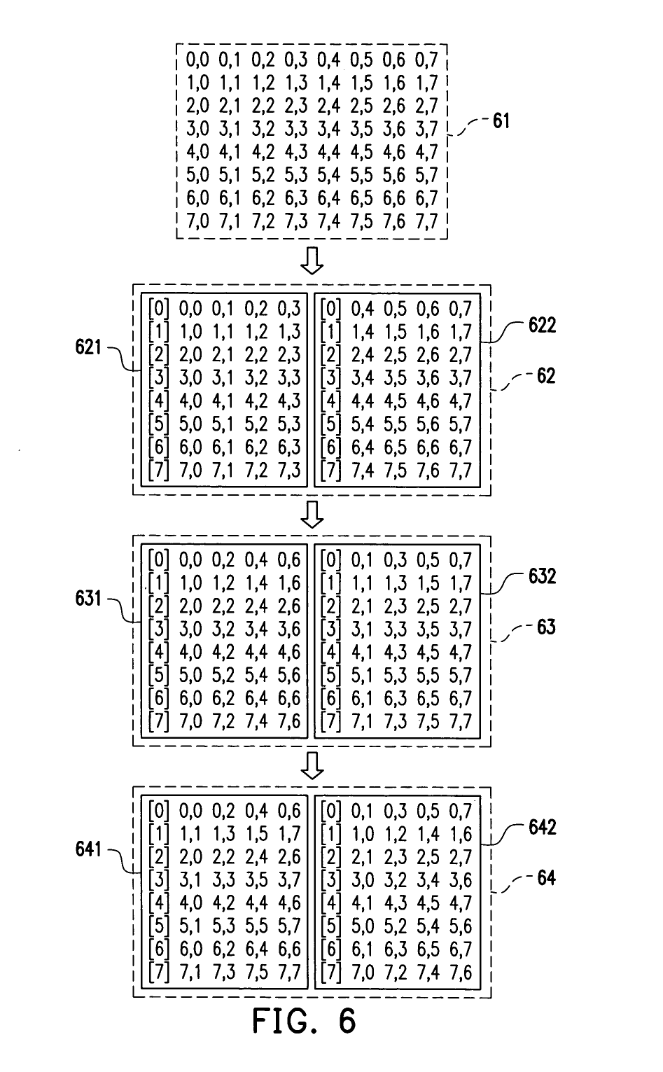

FIG. 6 illustrates a data structure for storing image data of 2 times' highest sub-sample rate according to another embodiment of the present invention. Referring to both FIGS. 5 and 6, firstly the source image receiver 51 receives an 8×8 image data 61. The 32 bits data is transferred to pixel processor 52 whenever the source image receiver 51 has received 4 pixels, and first buffer data 621 and second buffer data 622 are stored into first buffer 521 and second buffer 522 respectively according to the address configuration of data structure 62.

When the quantity of data in first buffer 521 and second buffer 522 of pixel processor 52 reaches a predetermined value (for example, 8 batches of data), then the first buffer data 621 of first buffer 521 and second buffer data 622 of second buffer 522 are read simultaneously by data buffer controller 520, and the desired even pixels and odd pixels are separated to obtain the first pixel group 631 and the second pixel group 632 of the data structure 63.

Thereafter, the pixels of every alternate pixel line of the first pixel group 631 and second pixel group 632 are arranged alternately by the memory controller 53 to obtain the first memory data 641 and the second memory data 642 of the data structure 64. Finally, the first memory data 641 and the second memory data 642 are written into the first memory block 541 and the second memory block 542 of memory 54 respectively.

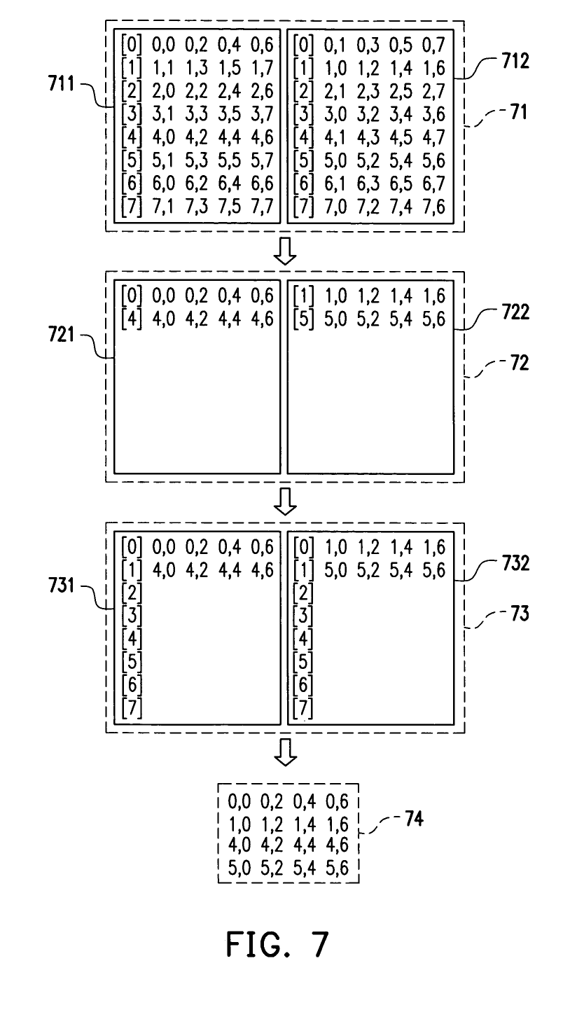

FIG. 7 illustrates the data structure of 2 times' highest sub-sample rate which reads 2 times' sub-sample rate data from the memory according to another embodiment of the present invention. Referring to both FIGS. 5 and 7, firstly memory controller 53 hop-reads memory data 711 from the first memory block 541 of memory 54 to obtain 2 times' sub-sample pixel group 721, and then it is stored into the first buffer 521 of pixel processor 52 as the first buffer data 731, wherein the so-called hop reading operation means, for example, only the first and fourth data are read. Thereafter, aforementioned operations are repeated until memory data 711 in the first memory block 541 has been read completely, or first buffer 521 of pixel processor 52 has been fully stored.

Then, hop-read memory data 712 in the second memory block 542 of memory 54 to obtain 2 times' sub-sample pixel group 722, and store it into the second buffer 522 of pixel processor 52 as the second buffer data 732. Repeat the above steps until the memory data 712 in the second memory block 542 has been read completely, or the second buffer 522 of pixel processor 52 has been fully stored.

Then, buffer data 731 in the first buffer 521 and buffer data 732 in the second buffer 522 of pixel processor 52 are read according to the data sequence required by hierarchical motion estimation 55 to obtain 2 times' sub-sample image 74, and then the 2 times' sub-sample image 74 is transferred to the hierarchical motion estimation 55.

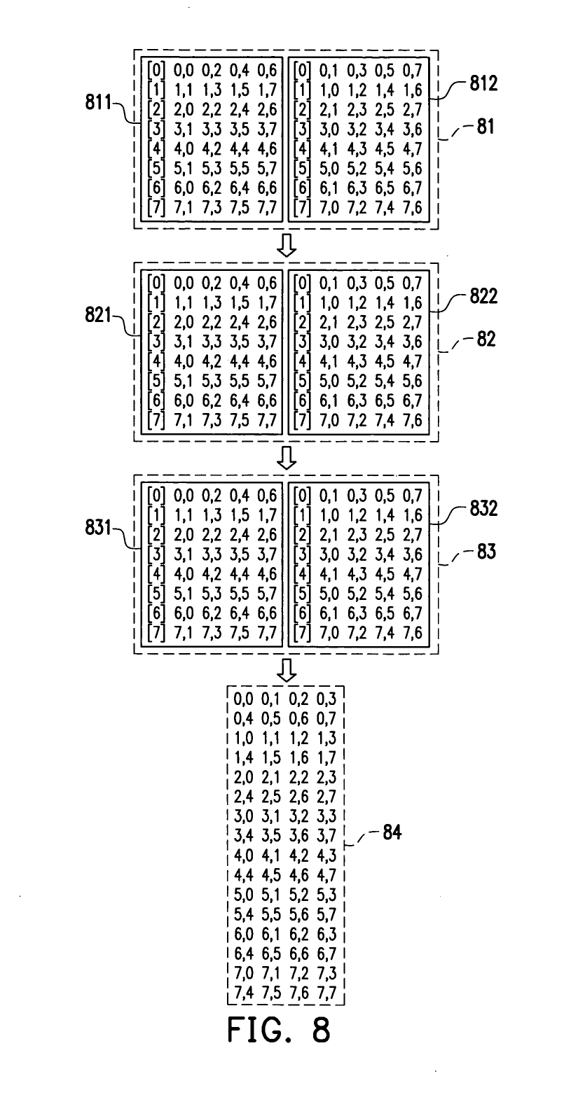

FIG. 8 illustrates the data structure of 2 times' highest sub-sample rate which reads original resolution image data from the memory according to another embodiment of the present invention. Referring to both FIGS. 5 and 8, firstly the first memory data 811 in the first memory block 541 of memory 54 is constantly read by memory controller 53 to obtain the first original resolution pixel group 821, and then it's stored into the first buffer 521 of pixel processor 52 as the first buffer data 831. Thereafter, the above operations are repeated until the first memory data 811 in the first memory block 541 has been read completely, or the first buffer 521 of pixel processor 52 has been fully stored.

Thereafter the second memory data 812 in the second memory block 542 of memory 54 is read constantly to obtain the second original resolution pixel group 822, and it's stored into the second buffer 522 of pixel processor 52 as the second buffer data 832. The above operations are repeated until the second memory data 812 in the second memory block 542 has been read completely, or the second buffer 522 of pixel processor 52 has been fully stored. Then, the first buffer data 831 in the first buffer 521 and the second buffer data 832 in the second buffer 522 of pixel processor 52 are read according to the data sequence required by other code module 56, and the separated parity pixels are recombined to obtain the original resolution image 84, and the original resolution image 84 is transferred to other code module 56.

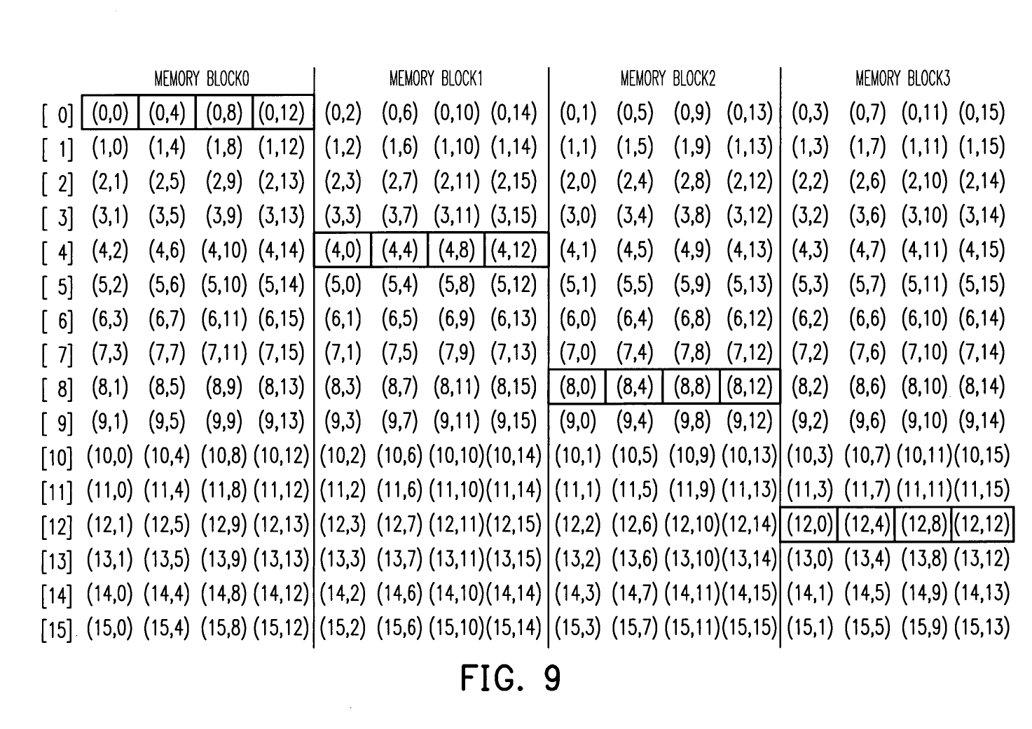

FIG. 9 illustrates the data structure for storing image data of 4 times' highest sub-sample rate according to yet another embodiment of the present invention, wherein the present embodiment uses data structure having 4 times' as the highest sub-sample rate. Firstly the pixels are separated according to 4 times' highest sub-sample rate; i.e. the parity pixels of the original image are separated to obtain 2 times' sub-sample image, then the parity pixels of the 2 times' sub-sample image are separated to obtain 4 times' sub-sample image data. To allow every memory store to be accessed alternately under all sub-sample rates, firstly, the 2 times' sub-sample parity pixels are assigned alternately into memory block {0,1} and {2,3} with 2 pixel lines as a unit, then the 4 times' sub-sample parity pixels are arranged alternately again in memory block {0,1} and {2,3} with 4 pixel lines as a unit. Finally, data in memory stores 0 and 2, and data in memory stores 1 and 3 are exchanged with 8 pixel lines as a unit, so that it's possible to obtain efficiently the image data of sub-sample rates of 0, 2, 4 when only original image is stored.

According to another embodiment of the present invention, it is to arrange/store odd number and even number of pixel groups alternately into the memory blocks of the memory with a plurality of the pixel lines as a unit, so that when they're read, the memory blocks will be opened alternately. Wherein if frame-based sub-sample image is used, then the odd number and even number of pixel groups are arranged alternately in the memory blocks of the memory with a plurality of frame pixel lines as a unit; if field-based sub-sample image is used, then in addition to arranging alternately the odd number and even number of pixel groups in the memory blocks of the memory with a plurality of field pixel lines as a unit, the method further includes arranging alternately the pixel groups belonging to the top field pixel line and the bottom field pixel line in the memory blocks of the memory.

In summary, in the method and apparatus of the present invention for saving image data, since a pixel processor is adopted to separate and recombine the pixel values of an image data into a plurality of pixel groups according to the highest sub-sample rate and the data width of the memory, and to store them separately into different memory blocks of the memory, so that it's possible to obtain images of 2ⁿ times' sub-sample rate efficiently when only full-resolution image data is stored and no sub-sample image needs to be stored separately. Further, the required memory space and bandwidth is reduced, so that the disadvantage of saving low-resolution image separately is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for saving image data, for obtaining images of full, 2, 4 . . . , and 2ⁿ times' sub-sample rates from a stored image data; the method comprising the following steps:
a. separating pixels P_{x,y} of an x^{th} pixel line into 2ⁿ pixel groups, referred to respectively as 1^{st}, 2^{nd} . . . , and n^{th} pixel group, pixels of the first pixel group including P_{x,1}, P_{x,2}ⁿ₊₁ . . . , P_{x, k*2}ⁿ₊₁, pixels of the second pixel group including P_{x,2}, P_{x, 2}ⁿ₊₂ . . . , P_{x, k*2}ⁿ₊₂, and so on, pixels of the 2ⁿth pixel group including P_{x, 2}ⁿ, P_{x, 2}ⁿ₊₂ⁿ . . . , P_{x, k*2}ⁿ₊₂ⁿ, wherein k, n, x, y are integers greater than 0; and
b. recombining the pixels of the pixel groups respectively according to a data width of a memory, and storing them respectively into 2ⁿ number of different memory blocks of the memory.

2. The method as claimed in claim 1, further comprising storing the pixel groups of each of the pixel lines into different memory blocks of the memory, so that pixels of pixel lines in each of the memory blocks belong to different pixel groups.

3. The method as claimed in claim 1, further comprises repeating step a. to separate every pixel line of the image data into 2ⁿ pixel groups.

4. The method as claimed in claim 3, wherein when the data stored in the pixel groups reach a certain quantity, the pixel groups are recombined according to the data width of the memory, and stored respectively into the memory blocks of the memory.

5. The method as claimed in claim 3, further comprising:
arranging/storing the odd number and even number of pixel groups alternately into the memory blocks of the memory with a plurality of pixel lines as a unit, so that the memory blocks can be opened alternately when they are read.

6. The method as claimed in claim 5, further comprising:
if frame-based sub-sample images are applied, arranging the odd and even number of pixel groups alternately in the memory blocks of the memory with a plurality of frame pixel lines as a unit.

7. The method as claimed in claim 5, further comprising:
if field-based sub-sample images are applied, arranging the odd and even number of pixel groups alternately in the memory blocks of the memory with a plurality of field pixel lines as a unit, wherein the method includes arranging alternately the pixel groups belonging to the top field pixel line and the bottom field pixel line in the memory blocks of the memory.

8. An apparatus for saving image data, comprising:
a pixel processor, for separating pixels of every pixel line of the image data into 2ⁿ pixel groups, wherein n is an integer greater than 0;
a memory controller coupled to the pixel processor, for recombining the pixels of the pixel groups respectively according to a data width of a memory; and
2ⁿ number of memory blocks coupled to the memory controller, for storing the recombined pixel groups, so that in each of the memory blocks, pixels of pixel lines belong to different pixel groups.

9. The apparatus as claimed in claim 8, wherein the pixel processor further comprises:
a plurality of data buffers, for storing a plurality of pixel values of the image data; and
a data buffer controller, coupled to the data buffers, for separating the pixel values stored in the data buffers into pixel groups according to the positions of the pixels in the image data, and storing them back into the data buffers according to the data width.

10. The apparatus as claimed in claim 9, wherein when the data buffers are fully stored with the pixel values, the pixel groups are stored into the memory blocks respectively after being recombined by the memory controller.
